(19) United States
(12) Patent Application Publication
(10) Pub. No.: US 2015/0136987 A1
(43) Pub. Date: May 21, 2015

(54) TERAHERTZ WAVE GENERATOR, TERAHERTZ WAVE DETECTOR, AND TERAHERTZ TIME DOMAIN SPECTROSCOPY DEVICE

(71) Applicant: CANON KABUSHIKI KAISHA, Tokyo (JP)

(72) Inventor: Kousuke Kajiki, Kasuga-shi (JP)

(21) Appl. No.: 14/405,542

(22) PCT Filed: Jul. 1, 2013
(86) PCT No.: PCT/JP2013/068569

§ 371 Date: Dec. 4, 2014

(30) Foreign Application Priority Data
Jul. 3, 2012 (JP) 2012-149208
May 28, 2013 (JP) 2013111460

(51) Int. Cl. G02F 1/365; G01J 3/28; G01J 3/10; G21K 5/02

(52) U.S. Cl. CPC G02F 1/365; G21K 5/02; G01J 3/28; G01J 3/108
USPC 250/339.07; 250/338.1; 250/493.1; 359/326

(57) ABSTRACT

Provided is a terahertz wave generator having the following structural feature in a plane perpendicular to an optical propagation direction of an optical waveguide. Specifically, 0<r1<r2 is satisfied, where r1 represents a radius of curvature of a terahertz wave emitting plane of a coupling member at a point A at which a line extending from the optical waveguide in the normal direction to a surface of a substrate crosses the terahertz wave emitting plane of the coupling member, and r2 represents a radius of curvature of a wavefront of a terahertz wave at the same point A. Here, r1 has a positive value when being convex in a propagation direction of the terahertz wave.

### TECHNICAL FIELD

The present invention relates to a terahertz wave generator that generates a terahertz wave containing electromagnetic wave components in a frequency domain from a millimeter wave band to a terahertz wave band (30 GHz to 30 THz), and a terahertz wave detector that detects a terahertz wave. Further, the present invention relates to a terahertz time domain spectroscopy device that uses at least one of the terahertz wave generator and the terahertz wave detector. In particular, the present invention relates to a generator or a detector including an electrooptic crystal that generates or detects an electromagnetic wave containing Fourier components in the above-mentioned frequency band by laser beam irradiation, and a tomography device or the like employing the terahertz time domain spectroscopy method (THz-TDS) using the generator or the detector.

### BACKGROUND ART

In recent years, a nondestructive sensing technology using a terahertz wave has been developed. As an application field of an electromagnetic wave having this frequency band, there is a technical field in which imaging is performed with a safe fluoroscopy device instead of an X-ray equipment. In addition, there have been developed a spectral technology for investigating physical properties such as a molecular binding state by determining absorption spectrum and complex permittivity inside a substance, a measurement technology for investigating physical properties such as carrier density, mobility, and conductivity, and an analysis technology of biomolecules. As a method of generating a terahertz wave, a method of using a nonlinear optical crystal is widely used. Typical nonlinear optical crystals include LiNbOₓ (hereinafter also referred to as LN), LiTaOₓ, NbTaOₓ, KTP, DAST, ZnTe, GaSe, GaP, and CdTe. A second-order nonlinear phenomenon is used for generating a terahertz wave. As the method, there are known a difference-frequency generation (DFG) using incidence of two laser beams having a frequency difference. Here, when two laser beams having different frequencies are caused to enter, a nonlinear polarization having a period corresponding to a difference frequency between the two laser beams is generated. In addition, in the nonlinear optical crystal, an energy state is excited by incidence of a laser beam, and an electromagnetic wave is radiated when an original energy state is restored. If the nonlinear optical crystal is nonlinearly polarized, an electromagnetic wave corresponding to the polarization frequency is radiated. If the polarization is carried out to have a terahertz wave frequency, the nonlinear optical crystal radiates a terahertz wave. In addition, there are known a method of generating a monochromatic terahertz wave by an optical parametric process and a method of generating a terahertz pulse by optical rectification with irradiation of a femtosecond pulse laser beam.

As a process of generating a terahertz wave from a nonlinear optical crystal in this way, an electrooptic Cerenkov radiation has been noted recently. This is a phenomenon in which, as illustrated in FIG. 10, a terahertz wave 101 is radiated in a conical manner like a shock wave in a case where a propagation group velocity of a laser beam 100 as an exciting source is faster than a propagation phase velocity of the generated terahertz wave. A radiation angle θ_{c} (Cerenkov angle) of the terahertz wave is determined by the following expression in accordance with a ratio of refractive index in the medium (nonlinear optical crystal) between light and the terahertz wave.

cos θ_{c}=v_{THz}/v_{g}=n_{g}/n_{THz}

where v_{g} and n_{g} represent a group velocity and a group refractive index of exciting light, respectively, and v_{THz} and n_{THz} represent a phase velocity and a refractive index of the terahertz wave, respectively. Up to now, there has been reported that a high intensity terahertz pulse is generated by optical rectification using the Cerenkov radiation phenomenon by causing a femtosecond laser beam with inclined wavefront to enter LN (see Non Patent Literature 1). In addition, there has been reported that a monochromatic terahertz wave is generated by a DFG method using a slab waveguide having a thickness sufficiently smaller than the wavelength of the generated terahertz wave in order to eliminate the necessity of the wavefront inclination (see Patent Literature 1 and Non Patent Literature 2). Further, there has been proposed a terahertz wave generator, a terahertz wave detector, and the like, which include an electrooptic crystal capable of modulating the generated terahertz wave at a relatively high speed by using an electrode to apply an electric field to an optical waveguide (see Patent Literature 2).

The examples of Patent Literatures 1 and 2 and Non Patent Literatures 1 and 2 relate to a proposal of improving extraction efficiency by enhancing terahertz waves generated by different wave sources by each other with phase matching in the radiation direction because the terahertz wave is generated by progressive wave excitation in those examples. Features of this radiation method include the fact that a relatively high intensity terahertz wave can be generated by using a nonlinear optical crystal, the fact that the terahertz wave is generated with high efficiency, and the fact that a terahertz wave band can be widened when absorption in the terahertz region due to phonon resonance unique to the crystal is selected on the high frequency side. In those technologies, compared with terahertz generation by using a photoconductive element, the generation band can be widened and the pulse width can be decreased in the case of terahertz wave pulse generation using the optical rectification. Therefore, it is expected that device performance can be enhanced in the case of application to a terahertz time domain spectroscopy device, for example.

As a device utilizing the Cerenkov radiation phenomenon, Patent Literature 3 discloses a device which propagates light in an optical waveguide made of a nonlinear optical crystal and generates a second harmonic wave having a frequency twice as high as that of the light by Cerenkov radiation. In Patent Literature 3, the second harmonic wave of the Cerenkov radiation has a conical shape, and a waveguide substrate has a function of collimating the wavefront with high flatness.

### CITATION LIST

### Patent Literature

PTL 1: Japanese Patent Application Laid-Open No. 2010-204488
PTL 2: Japanese Patent Application Laid-Open No. 2011-203718
PTL 3: Japanese Patent Application Laid-Open No. H02-081035

### Non Patent Literature

NPL 1: J. Opt. Soc. Am. B, vol. 25, pp. B6-B19, 2008.
NPL 2: Opt. Express, vol. 17, pp. 6676-6681, 2009.

### SUMMARY OF INVENTION

### Technical Problem

As described above, the terahertz wave is generated by the nonlinear effect. Therefore, it is considered that as optical power density in the optical waveguide is larger, the generated terahertz wave has higher power. This situation can be realized by the same laser power when the above-mentioned slab waveguide is decreased in width to be a ridge waveguide, for example. In this way, if the width of the optical waveguide is smaller than the wavelength of the terahertz wave, a radiation angle of the generated terahertz wave increases. However, in the methods described in Patent Literature 1 and Patent Literature 2, it is not easy to use the terahertz wave radiated to a region having a large radiation angle in a plane perpendicular to the optical propagation direction of the optical waveguide. In addition, in the method described in Patent Literature 3, there is disclosed a structure for suppressing a divergence of the generated Cerenkov beam so as to be collimated light and radiating the beam from the device, in which refraction or reflection is used for obtaining collimated light. However, when refraction is used, Fresnel loss of the terahertz wave is large. On the other hand, when reflection is used, the terahertz wave is radiated to the outside via two optical surfaces. Therefore, compared with a case where there is one optical surface, an influence of a scattering loss may become large depending on roughness of the optical surface. Therefore, a use efficiency of the terahertz wave may be limited.

### Solution to Problem

In view of the above-mentioned problems, according to an exemplary embodiment of the present invention, there is provided a terahertz wave generator, including: an optical waveguide formed on a substrate so as to include a core layer of an electrooptic crystal; and a coupling member configured to extract a terahertz wave into a space, which is generated from the optical waveguide when light propagates in the optical waveguide. 0<r1<r2 is satisfied, where r1 represents a radius of curvature of a terahertz wave emitting plane of the coupling member at a point A at which a line extending from the optical waveguide in a normal direction to a surface of the substrate crosses the terahertz wave emitting plane of the coupling member, in a plane perpendicular to the optical propagation direction of the optical waveguide, the radius of curvature r1 having a positive value when being convex in a propagation direction of the terahertz wave, and r2 represents a radius of curvature of a wavefront of the terahertz wave at the same point A.

### Advantageous Effects of Invention

In the terahertz wave generator according to the exemplary embodiment of the present invention, divergence in the plane perpendicular to the optical propagation direction of the optical waveguide for the terahertz wave radiated in a substantially conical shape can be suppressed by the coupling member having the terahertz wave emitting plane as described above. Therefore, a use efficiency of the terahertz wave can be improved.

Further features of the present invention will become apparent from the following description of exemplary embodiments with reference to the attached drawings.

### BRIEF DESCRIPTION OF DRAWINGS

FIGS. 1A, 1B, and 1C are structural diagrams of a terahertz wave generator a first embodiment of according to the present invention.

FIG. 2 is a structural diagram of an optical waveguide part of the terahertz wave generator according to the present invention.

FIGS. 3A, 3B, and 3C are explanatory diagrams of a function of converting a wavefront of a terahertz wave by a coupling member.

FIG. 4 is an explanatory diagram of another structure of the terahertz wave generator according to the present invention.

FIG. 5 is a structural diagram of a terahertz wave generator according to a second embodiment of the present invention.

FIG. 6 is a structural diagram of a terahertz wave generator according to a third embodiment of the present invention.

FIGS. 7A and 7B are structural diagrams of a tomography device according to a fifth embodiment of the present invention.

FIGS. 8A and 8B are structural diagrams of a terahertz wave detector according to a sixth embodiment of the present invention.

FIGS. 9A and 9B are structural diagrams illustrating the first embodiment from another viewpoint.

FIG. 10 is a conceptual diagram of an electrooptic Cerenkov radiation.

### DESCRIPTION OF EMBODIMENTS

Preferred embodiments of the present invention will now be described in detail in accordance with the accompanying drawings.

A terahertz wave generator according to an exemplary embodiment of the present invention has a feature in that a radius of curvature of a terahertz wave emitting plane of a coupling member is larger than a radius of curvature of a wavefront of a terahertz wave in a plane perpendicular to an optical propagation direction of an optical waveguide. Thus, a divergence of the terahertz wave radiated diverging from the optical waveguide is suppressed when the terahertz wave passes through the terahertz wave emitting plane of the coupling member so that a use efficiency of the terahertz wave is improved. In addition, the same structure can be used for converging and detecting an incident terahertz wave by a reversed process. More widely speaking, a shape of the coupling member of the element of the present invention is configured to increase a radius of curvature of the wavefront of the terahertz wave emitted from the coupling member after being emitted than before being emitted in a plane perpendicular to the optical propagation direction of the optical waveguide. The terahertz wave after being emitted from the coupling member becomes a substantially plane wave or the like.

Examples of the shape of the coupling member include a shape having an elliptic or circular cross section in a plane perpendicular to the optical propagation direction of the optical waveguide, a shape including at least a part of a cone shape or an elliptic cone shape, a shape including at least a part of an oblique cone shape or an oblique elliptic cone shape, and a shape including at least a part of a paraboloid shape. In addition, it is possible to adopt an offset shape in which a distance between a point A on the terahertz wave emitting plane of the coupling member and the optical waveguide is larger than a distance between the point A on the terahertz wave emitting plane of the coupling member and an axis of the cone shape or the elliptic cone shape of the coupling member. In addition, in the case of the terahertz wave generator, the shape of the coupling member may be a shape including at least a part of a half spherical shape or the like.

The electrooptic crystal for a first-order electro-optic effect used in the present invention has a second-order nonlinearity. In general, a practical electrooptic crystal and a nonlinear optical crystal having the second-order nonlinearity are substantially equivalent. In addition, the optical propagation direction of the optical waveguide as used herein is a direction in which a laser beam entering the optical waveguide substantially propagates (which means that some leakage is allowed in propagation).

By using a generator or a detector having this structure for a terahertz time domain spectroscopy device or a tomography device for imaging an internal structure of a sample by analyzing reflection light from the sample, it is possible to improve an internal penetration depth, a depth resolution, or the like. As to improvement of the use efficiency of the terahertz wave, in the methods of Patent Literature 1 and Patent Literature 2, a surface of the coupling member such as a prism in which the terahertz wave propagates is not a surface such as a half spherical surface. Therefore, it is difficult to effectively use the terahertz wave which is radiated to a region having a large radiation angle in the plane perpendicular to the optical propagation direction.

In the following, embodiments and examples of the present invention are described with reference to the attached drawings.

### First embodiment

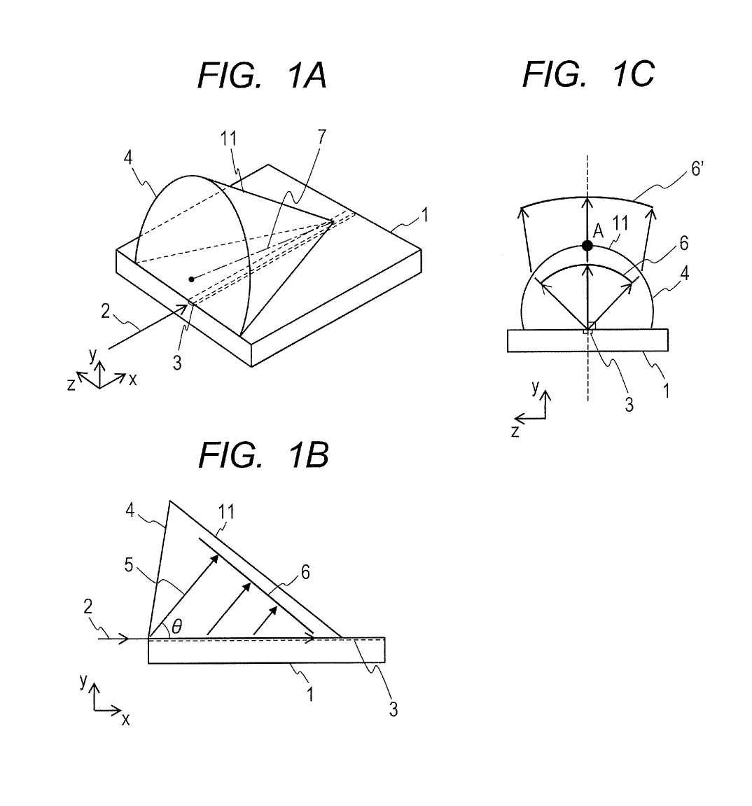

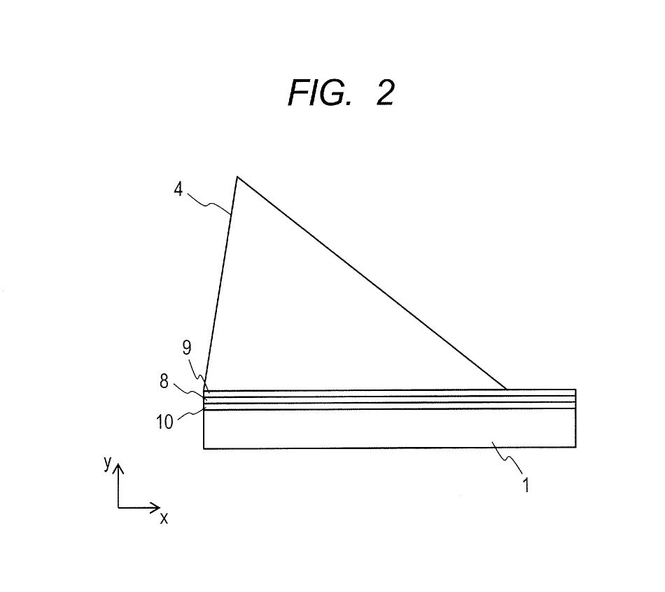

A terahertz wave generator using LN crystal according to a first embodiment of the present invention is described with reference to FIGS. 1A to 1C. FIG. 1A is a perspective view of the terahertz wave generator according to this embodiment, FIG. 1B is a cross-sectional view taken along a plane including the optical propagation direction (x-axis) of an optical waveguide 3 and the normal of a substrate (y-axis) at the center of the optical waveguide 3 in a z direction, and FIG. 1C is a cross-sectional view taken along a plane perpendicular to the optical propagation direction (x-axis) of the optical waveguide 3. The terahertz wave generator includes a substrate 1, the optical waveguide 3 formed on the substrate 1, and a coupling member 4 for extracting a generated terahertz wave 5 to an external space. The substrate 1 is Y-cut lithium niobate (LN).

A laser beam 2 enters the optical waveguide 3 from an end surface and propagates along the optical waveguide 3. As to coordinate axes, as illustrated in FIG. 1A, the optical propagation direction of the optical waveguide 3 is the x-axis, the normal direction of the substrate is the y-axis, and the direction perpendicular to the x-axis and the y-axis is a z-axis. The x-axis, the y-axis, and the z-axis of the LN crystal forming the optical waveguide 3 correspond to expression of the coordinate system. In addition, the laser beam 2 is a linearly polarized wave in the z-axis direction. With this structure, an electrooptic Cerenkov radiation as a second-order nonlinear phenomenon can be efficiently generated. In other words, LN crystal axes are set so that phase matching between the terahertz wave generated by a second-order nonlinear process and the laser beam can be obtained, and a phase matching condition is established between wave number vectors of the electromagnetic waves (the terahertz wave and the laser beam) relating to the second-order nonlinear process.

When the laser beam 2 enters the optical waveguide 3 as a polarized wave parallel to the z-axis and propagates along the optical propagation direction (x-axis), the terahertz wave 5 is generated from the surface of the crystal by the principle described in Non Patent Literature 1 referred to in Background Art or by optical rectification using an ultrashort pulse light source. As generally known, a crystal orientation of the LN crystal forming the optical waveguide 3 and a polarization state of the laser beam 2 are not necessarily limited to the above-mentioned form.

As illustrated in FIG. 2, which is a cross-sectional view taken along the plane including the optical propagation direction (x-axis) of the optical waveguide 3 and the normal of the substrate (y-axis) at the center of the optical waveguide 3 in the z direction, the optical waveguide 3 on the substrate 1 includes a core layer 8 formed of an MgO-doped LN crystal layer, and upper and lower cladding layers 9 and 10. Refractive indices of the upper and lower cladding layers 9 and 10 are lower than a refractive index of the core layer 8. With this structure, the laser beam 2 entering the optical waveguide 3 can propagate by total reflection.

A thickness necessary for the core layer 8 is a half or smaller of an equivalent wavelength of the terahertz wave 5 having a highest frequency (a highest frequency component) to be radiated externally in the core layer 8. In other words, a phase shift corresponding to a thickness of the core layer 8 is equal to or smaller than such a thickness that inversion and cancellation of each other do not occur on an equiphase wave surface of the generated terahertz wave 5.

The lower cladding layer 10 may also work as adhesive for bonding the core layer 8 to the substrate 1. The adhesive is necessary in the case where a bonding method is used for manufacturing but is not always necessary in the case where a diffusion method or the like is used for forming a doped layer. Even if there is no adhesive, because a refractive index of the MgO-doped LN layer is larger than that of the LN substrate, the substrate 1 becomes the lower cladding layer 10 and works as the optical waveguide. In other words, it is possible to adopt a structure in which the substrate 1 on the side opposite to the coupling member 4 works also as the lower cladding layer 10, that is, a structure in which only the lower cladding layer 10 exists without adhesive.

On the other hand, for the upper cladding layer 9, a resin, an inorganic oxide, or the like having a refractive index smaller than that of the LN is suitably used. The upper cladding layer 9 may work also as adhesive for fixing the coupling member 4 (described later). A thickness of this upper cladding layer 9 is desired to be thick enough for functioning as a clad when the laser beam 2 propagates in the core layer 8 and is thin to such an extent that an influence of a multiple reflection or loss can be neglected when the coupling member 4 radiates the terahertz wave 5 externally. As to the former condition, such a thickness is desired that light intensity at an interface between the optical waveguide 3 and the coupling member 4 becomes 1/e² or smaller of light intensity in the core layer 8 (e is a base of natural logarithm). As to the latter condition, it is desired that the thickness be approximately 1/10 or smaller of the equivalent wavelength λ_{eq} of the terahertz wave 5 to be radiated externally having a highest frequency (a highest frequency component) in the upper cladding layer 9. It is because, in a structure having a size of 1/10 of the wavelength, influences of reflection, scattering, refraction, and the like can be regarded as negligible for an electromagnetic wave having that wavelength, in general.

In other words, in this structure, the optical waveguide has a core layer to be a core for the light and a cladding layer to be a clad for the light, and the cladding layer is sandwiched between the coupling member and the core layer. Then, a thickness “d” of the cladding layer satisfies a<d<λ_{eq}/10, where “a” represents a thickness when light intensity of the light becomes 1/e² of light intensity in the core layer, and λ_{eq} represents an equivalent wavelength in the cladding layer of the wavelength corresponding to the highest frequency of the terahertz wave. However, the terahertz wave generator of the present invention can generate a terahertz wave even in a thickness outside the desired range.

Considering that the generation method is a method using the nonlinear effect, it is desired that a width of the optical waveguide 3 in the lateral direction (z direction) be small. It is because power density of the terahertz wave 5 has a dependence proportional to the square of power density of the laser beam 2 (peak power density in the case of a pulse) in principle. However, there is a disadvantage if a width of the optical waveguide 3 is too small. For instance, there is a case where a coupling efficiency from the laser beam 2 to the optical waveguide 3 decreases, or a case where a propagation loss increases. Considering these circumstances, it is desired to set the width of the optical waveguide 3 in the lateral direction (z direction) as a direction perpendicular to both the optical propagation direction of the optical waveguide and the normal direction to the substrate to be approximately one to ten times a main wavelength of the laser beam 2, for example. Other than that, it is also necessary to consider that power of the terahertz wave 5 may be saturated by a phenomenon such as an optical damage depending on power of the laser beam 2.

The width of the optical waveguide 3 in the lateral direction (z direction) is more desired to be such a degree that the laser beam 2 entering the optical waveguide 3 can propagate in a single mode. It is because a peak intensity of the laser beam 2 is decreased by modal dispersion along with the propagation in the optical waveguide when the laser beam 2 propagates in the optical waveguide 3 in a multiple mode. If the peak intensity of the laser beam 2 decreases, a conversion efficiency to the terahertz wave 5 is decreased, which is not desired. According to a simplified calculation using an equation for a step-index optical fiber (see “Foundation of Optical Waveguide”, p. 65, CORONA PUBLISHING CO., LTD.), it is desired that the width of the optical waveguide 3 in the lateral direction (z direction) be approximately 6 μm or smaller when the main wavelength contained in the laser beam 2 is 1.6 μm, for example.

However, this is a result obtained by calculation using a model including the cladding layer made of LN around the core layer made of Mg-doped LN. In addition, it is generally known that whether or not to propagate in the single mode depends also on an incident condition of the laser beam 2 (NA, incident angle, spot size, and the like). As a method of manufacturing the structure of the optical waveguide 3 in the lateral direction (z direction in FIG. 1A), there is a method of providing a refractive index difference with respect to a peripheral region by increasing a refractive index of the core layer 8 by Ti diffusion, a method of forming the core layer 8 into a ridge shape by etching so as to fill the peripheral region with resin or the like, or other such method. In addition, it is preferred that a height of the optical waveguide in the normal direction to a surface of the substrate be 1/10 or smaller of the main wavelength contained in the terahertz wave.

There may be multiple optical waveguides 3 instead of one optical waveguide 3. For instance, if an optical damage occurs when a total power of the laser beam 2 is input to one optical waveguide 3, the laser beam 2 may be split and caused to enter multiple optical waveguides 3 for a purpose of decreasing the power density. There is also a usage in which multiple optical waveguides 3 having different structures or materials are prepared, and the laser beam 2 is caused to enter one of the optical waveguides 3 for generating the terahertz wave 5 having desired characteristics in accordance with a purpose at that time. In addition, it is also possible to interfere the terahertz waves 5 generated from multiple optical waveguides 3 to adjust a beam shape or a beam direction of the terahertz wave 5. As a matter of course, a structure for preventing the terahertz waves 5 in desired extraction directions from interfering to cancel each other is necessary. As to an arrangement method for the multiple optical waveguides 3, there are various methods including a method of arranging the multiple optical waveguides 3 in the z direction, a method of arranging the multiple optical waveguides 3 in the y direction, and a method of arranging the multiple optical waveguides 3 in a nonparallel manner.

The optical waveguide 3 is linear in FIG. 1A, but the optical waveguide 3 may be curved. A cross section of the laser beam 2 entering the optical waveguide 3 may be a circular shape or an elliptic shape. The elliptic laser beam 2 is used in a case where a cross-sectional shape of the optical waveguide 3 is a rectangle, for example. In order to form an elliptic cross section of the laser beam 2, there is a method of, for example, condensing the laser beam 2 by using a rod lens having a rod-like shape.

The generated terahertz wave 5 can be extracted externally (to a space in this case) via the coupling member 4. A Cerenkov radiation angle determined by a refractive index difference between the laser beam 2 and the terahertz wave 5 in the LN is approximately 65 degrees. Material conditions of the coupling member 4 are as follows. The terahertz wave 5 needs to be extracted as a progressive wave in the coupling member 4 without total reflection at the interface with the optical waveguide 3, and a loss of the terahertz wave 5 needs to be small. As a material that satisfies these conditions, high resistance silicon (Si) is suitably used, for example. In this case, an angle θ_{clad} between the propagation direction of the terahertz wave 5 propagating in the coupling member 4 and the optical propagation direction (x-axis) of the optical waveguide 3 (see θ in FIG. 1B) is approximately 49 degrees.

The above-mentioned width of the optical waveguide 3 in the lateral direction (z direction), which is typically approximately 16 μm or smaller and is desirably approximately 6 μm or smaller as described above for a main wavelength of 1.6 μm of the laser beam 2, is smaller than a wavelength of the terahertz wave 5. For instance, the equivalent wavelength of the terahertz wave 5 in the material of Si (having a refractive index of 3.42) of the coupling member 4 is approximately 88 μm at 1 THz (corresponding to a vicinity of the peak frequency). Therefore, it can be regarded that the terahertz wave 5 is generated from a point light source in approximation in a plane perpendicular to the optical propagation direction (x-axis) of the optical waveguide 3. Therefore, the terahertz wave 5 is radiated up to an angle close to the z direction (left and right direction in FIG. 1C).

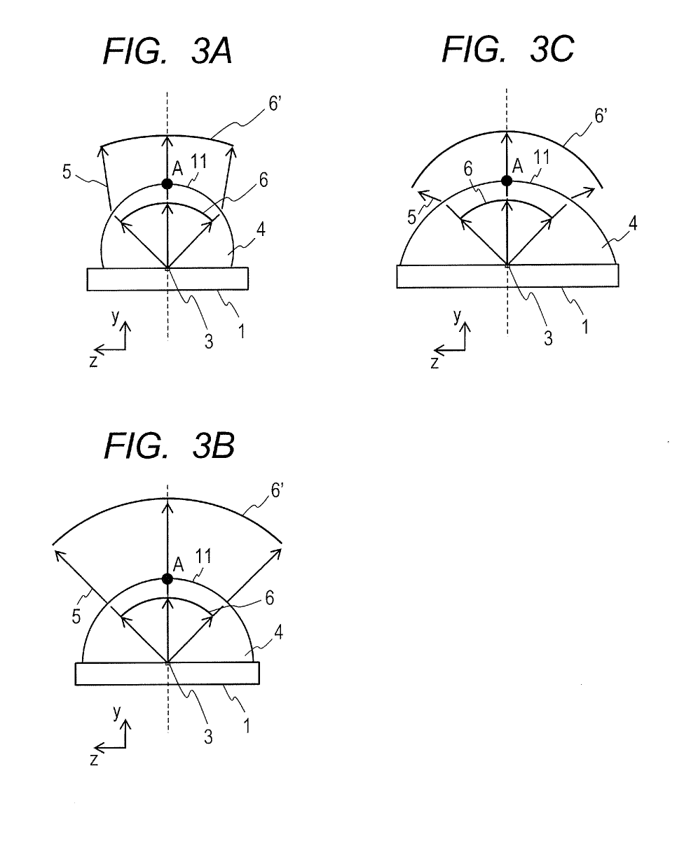

Based on the above description, a structure for improving use efficiency of the terahertz wave 5 is described with reference to FIGS. 3A, 3B, and 3C. FIGS. 3A, 3B, and 3C are cross-sectional views taken along a plane perpendicular to the optical propagation direction (x-axis) of the optical waveguide 3 and illustrate manners of refraction of the terahertz wave 5 and conversion of wavefronts 6 and 6′. In this cross section, a radius of curvature of a terahertz wave emitting plane 11 of the coupling member 4 is r1 (which is constant herein for simplifying the description). In addition, a radius of curvature of the wavefront 6 of the terahertz wave 5 at a position reaching the terahertz wave emitting plane 11 of the coupling member 4 is r2 (which is also constant for simplifying the description). A point A indicates a point where a line extending from the optical waveguide 3 in the normal direction to the surface of the substrate 1 crosses the terahertz wave emitting plane 11 of the coupling member 4. FIG. 3A corresponds to the case of r1<r2, FIG. 3B corresponds to the case of r1=r2, and FIG. 3C corresponds to the case of r1>r2.

In the case of FIG. 3A, a radius of curvature of the wavefront 6′ of the terahertz wave 5 after being emitted from the terahertz wave emitting plane 11 of the coupling member 4 is larger than a radius of curvature of the wavefront 6 before being emitted. In other words, a divergence degree of the terahertz wave 5 is decreased. In the case of FIG. 3B, the terahertz wave 5 is emitted without refraction at the terahertz wave emitting plane 11 of the coupling member 4. In the case of FIG. 3C, a radius of curvature of the wavefront 6′ of the terahertz wave 5 after being emitted is smaller than a radius of curvature of the wavefront 6 before being emitted. In other words, a divergence degree of the terahertz wave 5 is increased. By adopting the structure illustrated in FIG. 3A, it is possible to use a terahertz wave 5 having a large radiation angle radiated in a direction close to the z-axis as well.

To summarize, it is necessary to satisfy 0<r1<r2, where r1 represents a radius of curvature of the terahertz wave emitting plane 11 of the coupling member 4 at the point A, and r2 represents a radius of curvature of the terahertz wave at the same point A. It is more desired to satisfy 0<r1<r2 also in another part of the terahertz wave emitting plane 11 where power of the terahertz wave 5 is large.

Here, the part where power of the terahertz wave 5 is large means a range of a radiation angle of +/−45 degrees with respect to the direction from the optical waveguide 3 to the point A in the cross section of FIG. 3A, for example. This value corresponds to a radiation angle that is a half of a radiation angle in which power density becomes maximum, provided that a radiation pattern of the terahertz wave 5 is generated by dipole radiation having an axis in the z-axis direction. In other words, concerning the terahertz wave propagating in a range of inclination of 45 degrees or smaller from the propagation direction of the terahertz wave passing through the point A in a plane perpendicular to the optical propagation direction of the optical waveguide, it is preferred that a radius of curvature of the emitting plane be smaller than a radius of curvature of the wavefront of the terahertz wave in the terahertz wave emitting plane.

With the structure of this embodiment described above, use efficiency of the terahertz wave 5 can be improved.

The plane defining the radius of curvature may be a plane including a direction perpendicular to the optical propagation direction of the optical waveguide (z-axis direction) and a direction in which an angle to the optical propagation direction of the optical waveguide becomes a Cerenkov angle (see FIGS. 9A and 9B). FIG. 9A is a cross-sectional view of the terahertz wave generator according to this embodiment taken along a plane including the optical propagation direction (x-axis) of the optical waveguide 3 and the normal direction to the substrate (y-axis) at the center of the optical waveguide 3 in the z direction, and FIG. 9B is a cross-sectional view taken along a line 9B-9B. In this cross-sectional view, a point on the terahertz wave emitting plane and on a plane including the optical waveguide 3, the normal direction to the substrate 1, and the optical propagation direction of the optical waveguide 3 is a point B (see FIG. 9B). In this case, a shape of the terahertz wave emitting plane of the coupling member 4 in this cross-sectional view includes a circular arc having a radius rL1 at least in part, and 0<rL1<rL2 is satisfied where rL2 represents a longest distance from the optical waveguide 3 to the circular arc. In other words, in this cross-sectional view, the terahertz wave emitting plane of the coupling member includes at least a circular arc part having the radius rL1 in a part that is not held in contact with the substrate, and 0<rL1<rL2 is satisfied where rL2 represents a longest distance from the optical waveguide to the circular arc part. The value rL2 can be considered to be a radius of curvature of the wavefront 6 of the terahertz wave 5 at a position reaching the point B on the terahertz wave emitting plane 11 of the coupling member 4 in this cross-sectional view (which is constant for simplifying the description). Here, the circular arc part may include a range in which the inclination from the propagation direction of the terahertz wave passing through the point B is smaller than 45 degrees.

In addition, a distance in which a part of the terahertz wave having a substantially large power propagates in the coupling member may be equal to or larger than the equivalent wavelength in the coupling member of a wavelength corresponding to the highest frequency of the terahertz wave. In addition, in a plane perpendicular to the optical propagation direction of the optical waveguide, the following structure can be adopted. A radius of curvature of the emitting plane at the point A where the line extending from the optical waveguide in the normal direction to the substrate surface crosses the terahertz wave emitting plane of the coupling member is r1 which has a positive value in the case of convex in the terahertz wave propagation direction. A propagation distance from a generation point of the terahertz wave reaching the point A is rM2. In this case, it is possible that 0<r1<rM2 is satisfied.

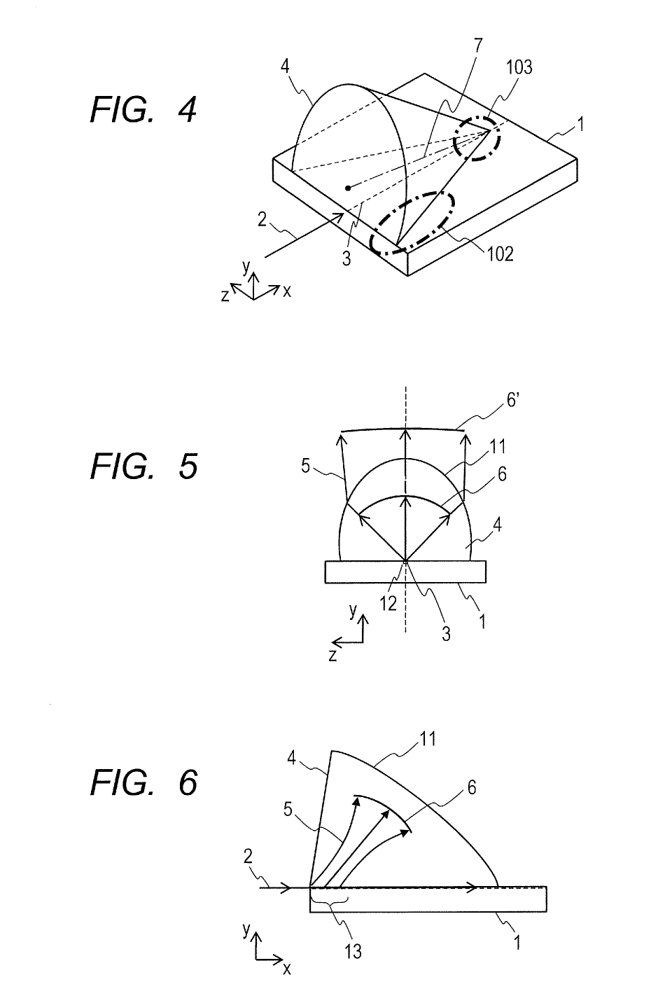

Concerning shapes or the like of parts of the coupling member 4 and the substrate 1 other than main parts thereof, it is possible to adopt various forms in the range in which the effect can be obtained by setting a positional relationship (including a size) of the optical waveguide 3 and the coupling member 4 as described above. For instance, a shape of the coupling member 4 may be any shape for a part in which the terahertz wave 5 has a small power. For instance, as viewed from the optical waveguide 3, a part of a surface in the direction close to the z-axis (vicinity of a region 102 in FIG. 4), a part in which terahertz wave generating ability of the laser beam 2 is sufficiently weakened during propagation in the optical waveguide 3 (vicinity of a region 103 in FIG. 4) may be cut out.

It is desired that a plane of the coupling member 4 on an incident side of the laser beam 2 be not perpendicular to the surface of the substrate 1 but inclined thereto. It is because, if the terahertz wave 5 is reflected by this plane, the reflected wave may be stray light depending on a reflection angle. For instance, if this plane is inclined by 10 degrees or larger from the direction perpendicular to the surface of the substrate 1 in the optical propagation direction of the optical waveguide 3, the terahertz wave reflected by this plane is totally reflected when being emitted from the coupling member 4 made of Si, and therefore it is considered that there is no influence. However, there is considered a case of a structure in which the terahertz wave 5 reaching the terahertz wave emitting plane 11 without being reflected by this plane is emitted at an incident angle of 0 degrees.

A size of the substrate 1 may be decreased within a range that can keep the size of the optical waveguide 3. In addition, a shape of a back surface (surface opposite to the surface on which the optical waveguide 3 is formed) is arbitrary. For instance, in order to prevent light reflected by the back surface from being stray light, it is possible to cut diagonally. In order to use the terahertz wave 5 radiated from the back surface, it is possible to adopt a prism shape or a lens shape, or the like. As to the material, various materials such as Si or a resin can be used.

In the method disclosed in Patent Literature 3, the generated second harmonic wave Cerenkov beam is radiated externally from the device with divergence being suppressed to be collimated light, and refraction or reflection is used for obtaining the collimated light. Here, for comparison with this embodiment, the terahertz wave generated from the optical waveguide as exemplified in this embodiment is radiated from silicon (having a refractive index of 3.42) as the coupling member. In the case of using refraction as described in Patent Literature 3, power transmittance becomes 40% because of Fresnel loss when the light is emitted, which is smaller than 70% in the case of orthogonal transmission. On the other hand, in the case of using reflection as described in Patent Literature 3, the terahertz wave is radiated externally through the two optical surfaces. Therefore, compared with the case of the only one optical surface, an influence of the scattering loss may be increased depending on roughness or accuracy of the optical surface. As an example, there is considered a case where one reflecting surface is added. Supposing that the wavelength of the terahertz wave is 300 μm (the frequency is 1 THz), an effective wavelength inside Si is 87.7 μm (=300 μm/3.42 μm). In general, in the range of surface roughness or accuracy larger than λ/20 (=4.4 μm) on the reflecting surface, it is necessary to consider scattering and wavefront distortion in many cases. In order to process silicon as a material that is hard to cut into a conical shape at a surface roughness or surface accuracy of a few micrometers, cost may be increased. When the wavelength of the terahertz wave is 60 μm (frequency of 5 THz), λ/20 becomes 0.9 μm, which is a more conspicuous problem. In this embodiment, because the terahertz wave is radiated externally from the silicon through only one transmission surface, scattering and wavefront distortion can be reduced.

By setting the structure of the optical waveguide, the axis directions of the electrooptic crystal, the structure of the coupling member, and the like as described above, use efficiency of the terahertz wave by photoexcitation and Cerenkov radiation can be improved.

### Example 1

Example 1 corresponding to the first embodiment is described in more specifically. In this example, the MgO-doped LN layer (core layer) is formed to have a thickness of 3.8 μm and a width of 5 μm. In addition, the upper cladding layer 9 as a buffer layer (low refractive index buffer) having a width of 5 μm is formed of optical adhesive having a thickness of 2 μm. In this example, supposing to support up to 7 THz, for example, the wavelength of the terahertz wave in the free space is approximately 43 μm. Supposing that the thickness of the upper cladding layer 9 is the value obtained by dividing the equivalent wavelength by a refractive index of 1.5 of the buffer layer, the thickness of the upper cladding layer 9 is set to 2 μm so as to be λ_{eq}/10 (=43/1.5/10) or smaller as described above in the first embodiment.

Further, the coupling member 4 made of high resistance Si is held in intimate contact with the buffer layer. Here, the cross-sectional shape of the coupling member is an elliptic or circular shape in a plane perpendicular to the optical propagation direction of the optical waveguide. A shape of the coupling member 4 is a part of a cone shape having a half apex angle of 33 degrees, for example. In addition, a distance between the point A and the optical waveguide is gradually decreased along the propagation direction of the optical waveguide. The optical waveguide 3 is disposed to virtually cross the apex of the cone of the coupling member 4 at an angle of 7 degrees. In other words, at the apex of the cone shape of the coupling member 4, the angle between an axis 7 of the cone shape and the optical waveguide 3 illustrated in FIG. 1A is 7 degrees. Here, “virtually” means that there is a case where the coupling member is absent at this position. Such a structure of the coupling member 4 is illustrated schematically in FIG. 1A. However, the axis of the cone shape and the optical waveguide 3 may be identical to each other. In addition, the above-mentioned cone shape is generally a cone having a circular base, and an axis connecting the apex and the center of the base may be perpendicular or inclined with respect to the base (an oblique cone shape in the latter case).

The length of the optical waveguide 3 in the optical propagation direction is 10 mm. The laser beam 2 is a pulse laser beam having a peak wavelength of 1.6 μm, a pulse width of 20 fs, and an average power of 60 mW and enters an end surface of the optical waveguide 3 as a beam having a cross sectional diameter of approximately 6 μm (of a part having intensity equal to or larger than 1/e² of a maximum intensity). The incident laser beam 2 propagates in the optical waveguide 3 in the single mode. In the plane that includes an incident end of the laser beam 2 and is perpendicular to the optical propagation direction (x-axis) of the optical waveguide 3 (y-z plane to be an incident plane of the laser beam 2), the cross section of the coupling member 4 has a circular shape having a diameter of 20 mm. In the incident plane of the laser beam 2, the optical waveguide 3 is disposed at a distance of 1.9 mm from the axis 7 of the cone.

With this structure, r1<r2 can be satisfied. As described above, r1 is the radius of curvature of the terahertz wave emitting plane 11 of the coupling member 4. In addition, r2 is the radius of curvature of the wavefront 6 of the terahertz wave 5 at a position reaching the terahertz wave emitting plane 11 of the coupling member 4. Using this terahertz wave generator, it is possible to reduce the divergence degree of the terahertz wave and to improve use efficiency of the terahertz wave.

According to the above description of the first embodiment, it is possible to consider a shape of the coupling member 4 in which a part of a hyper hemispherical lens is cut out. However, in the hyper hemispherical lens, the terahertz wave 5 generated in a region deviated from its focal point by a few hundred micrometers or larger cannot be used because of an influence of aberration. On the other hand, in the structure of the conical shape of this example, it is possible to use also the terahertz wave 5 generated over a few millimeters in the optical propagation direction of the optical waveguide 3.

### Example 2

Example 2 corresponding to the first embodiment is described in more specifically. In this example, the structure of the optical waveguide is the same as that of Example 1. In this example, a cross-sectional shape of the coupling member in the plane perpendicular to the optical propagation direction of the optical waveguide is a circular shape. A shape of the coupling member 4 is a part of a cone shape having a half apex angle of 31 degrees. In addition, the distance between the point A and the optical waveguide is gradually decreased along the propagation direction of the optical waveguide. The optical waveguide 3 is disposed to virtually cross the apex of the cone of the coupling member 4 at an angle of 9 degrees. In other words, at the apex of the cone shape of the coupling member 4, the angle between the axis 7 of the cone shape and the optical waveguide 3 is 9 degrees. Here, “virtually” means that there is a case where the coupling member is absent at this position.

In the plane that includes an incident end of the laser beam 2 and is perpendicular to the optical propagation direction (x-axis) of the optical waveguide 3 (y-z plane to be an incident plane of the laser beam 2), the cross section of the coupling member 4 has a circular shape having a diameter of 18.5 mm. In the incident plane of the laser beam 2, the optical waveguide 3 is disposed at a distance of 2.5 mm from the axis 7 of the cone. With this structure, r1<r2 can be satisfied.

As described above, r1 is the radius of curvature of the terahertz wave emitting plane 11 of the coupling member 4. In addition, r2 is the radius of curvature of the wavefront 6 of the terahertz wave 5 at a position reaching the terahertz wave emitting plane 11 of the coupling member 4. Using this terahertz wave generator, it is possible to reduce the divergence degree of the terahertz wave and to radiate the terahertz wave similar to collimated light.

Such a condition can be expressed by a/b=0.19 where “a” represents a distance from the optical waveguide 3 to the axis of the cone (coupling member 4) in a line extending from the optical waveguide 3 in the normal direction to the substrate surface, and “b” represents a distance from the axis of the cone to the terahertz wave emitting plane 11 of the coupling member 4. In the above-mentioned structure, it is supposed that a positional deviation corresponding approximately to a wavelength of the terahertz wave (for example, 400 μm) is allowable. Then, it is desired to satisfy 0.16≦a/b≦0.22. Supposing that the wavelength of the terahertz wave is 300 μm, it is desired to satisfy 0.17≦a/b≦0.21. In the structure of Example 1, a/b=0.15 is satisfied.

### Second Embodiment

### Elliptical Shape

A second embodiment of the present invention is described with reference to FIG. 5. In this embodiment, unlike the first embodiment described above, the structure has a feature in that a shape of the coupling member 4 includes at least a part of an elliptic cone. The concept of refracting the generated terahertz wave 5 at the terahertz wave emitting plane 11 of the coupling member 4 so as to improve use efficiency of the terahertz wave 5 is the same as in the first embodiment. Here, the elliptic cone shape is generally a cone having a base having an elliptic shape, and an axis connecting the apex and the center of the base may be perpendicular or inclined with respect to the base (an oblique elliptic cone shape in the latter case). Here, the elliptic cone has an elliptic cross section perpendicular to the axis of the cone. FIG. 5 is a cross-sectional view of the terahertz wave generator taken along the elliptic surface.

It is generally known that the electromagnetic wave radiated from a point light source disposed at a focal point position of an elliptic lens (a focal point farther from the emitting plane between two focal points of the ellipse) can be collimated by the elliptic lens. Unlike this case, in this embodiment, the terahertz wave 5 for Cerenkov radiation is radiated from the optical waveguide 3 in a conical shape. However, as described above in the first embodiment, availability of the elliptic shape can be found by considering a plane perpendicular to the optical propagation direction of the optical waveguide 3. In other words, in this plane, the shape of the terahertz wave emitting plane 11 of the coupling member 4 is set to be elliptic, and the optical waveguide 3 is disposed at a focal point 12 of the elliptic shape. Thus, generation of the collimated light by the elliptic shape can be approximately realized (see FIG. 5).

In this embodiment, the focal points 12 of ellipses in cross sections perpendicular to the axis of the elliptic cone of the coupling member 4 are on a straight line. Therefore, it is preferred to dispose the optical waveguide 3 corresponding to the straight line. The wavefront 6′ of the terahertz wave 5 radiated from the terahertz wave generator described above is substantially a plane. In particular, compared with the shape of Example 1, a difference of curvature between two orthogonal directions of the wavefront (a left and right direction of the drawing sheet and a direction perpendicular to the drawing sheet of FIG. 5) is decreased. In general, if the wavefront is a plane, it is easy to handle optically. Therefore, according to this embodiment, it is possible to increase use efficiency of the terahertz wave and to realize the terahertz wave generator that can easily handle the beam.

### Third embodiment

A third embodiment of the present invention is described with reference to FIG. 6. In this embodiment, a shape of the coupling member 4 in a plane (x-y plane) including the optical propagation direction of the optical waveguide 3 (x-axis) and the normal to the substrate (y-axis) is defined. In this plane, the structure has a feature in that r_{A}1<r_{A}2 is satisfied where r_{A}2 represents a radius of curvature of the wavefront 6 of the terahertz wave 5 reaching the emitting plane 11 of the coupling member 4, and r_{A}1 represents a radius of curvature of the emitting plane 11 of the coupling member 4. Thus, the divergence degree of the terahertz wave 5 can be reduced also in the x-y plane before being emitted. This structure is effective in a case where a substantial size 13 (see FIG. 6) of a region in which the terahertz wave 5 is generated in the optical propagation direction of the optical waveguide 3 (x direction) is small, and the terahertz wave can be regarded as diverging light along with propagation.

This situation corresponds to, for example, a case where a very short pulse laser beam 2 (for example, shorter than 10 fs) enters. Along with propagation in the optical waveguide 3, a peak value of the laser beam 2 decreases because of LN material dispersion or the like, and a decreasing degree is particularly large in a case of a short pulse (a large spectrum width). A generated power of the terahertz wave 5 is considered to be proportional to the square of a peak value of the laser beam 2 in principle because of the nonlinear effect. Therefore, along with propagation of the laser beam 2 in the optical waveguide 3, the generated power of the terahertz wave 5 is decreased. Due to this effect, a size of a substantial generation region of the terahertz wave 5 in the x-y plane may be reduced. In addition, the nonlinear effect that does not relate to generation of the terahertz wave 5 may occur strongly so that the energy is converted into an electromagnetic wave having a frequency other than the frequency relating to the terahertz wave 5. In this case or also in a case where the laser beam 2 is not appropriately confined in the optical waveguide 3, the substantial generation region of the terahertz wave 5 may be reduced.

In the above description, the generation region size of the terahertz wave 5 is described. However, it can be considered that the terahertz wave 5 may reach the emitting plane before being sufficient diverging light depending on a distance between a generation spot of the terahertz wave 5 and the terahertz wave emitting plane 11 of the coupling member 4. The relationship can be expressed in an organized manner to a certain extent by considering the Rayleigh range of the terahertz wave 5 assuming that the terahertz wave 5 is generated as collimated light having a Gaussian distribution. Here, the Rayleigh range means a distance at which a beam diameter of the Gaussian beam generated with an infinite radius of curvature is increased to the square root of 2 of a value at the generation spot. For instance, supposing that the size of the generation region of the terahertz wave 5 is 0.5 mm (power 1/e² total width), the wavelength is 300 μm, and a propagation medium is Si (having a refractive index of 3.42), the Rayleigh range becomes approximately 2 mm. If a distance between the generation spot of the terahertz wave 5 and the terahertz wave emitting plane 11 of the coupling member 4 is larger than this value, for example, if the distance is 10 mm, it is considered that the terahertz wave 5 is similar to diverging light in a vicinity of the terahertz wave emitting plane 11. In this case, the radius of curvature of the terahertz wave 5 after propagating 10 mm is approximately 11 mm. Therefore, it is preferred to set the radius of curvature of the coupling member 4 in the x-y plane to be smaller than 11 mm.

Further, it is considered that the substantial size 13 of the generation region of the terahertz wave 5 in the optical propagation direction of the optical waveguide 3 (x direction) is larger than a generation region size of the terahertz wave 5 in the lateral direction (z direction) of the optical waveguide 3 in many cases. In these cases, the radius of curvature of the emitting plane of the coupling member 4 in the x-y plane described above in this embodiment is generally larger than the radius of curvature in the y-z plane. In other words, the curvature of the coupling member 4 is different between the x-y plane and the y-z plane.

According to this embodiment, if the terahertz wave in the x-y plane can be regarded as diverging light, use efficiency of the terahertz wave can be improved.

### Fourth Embodiment

### Difference Frequency Method

In the above description, there is mainly described the example in which a femtosecond laser beam is used as the laser beam and caused to enter the optical waveguide of the terahertz wave generator so that the terahertz wave pulse is generated by optical rectification in the optical waveguide. In contrast, in a fourth embodiment of the present invention, a laser beam having two different oscillation frequencies ν1 and ν2 is caused to enter, and a monochromatic terahertz wave corresponding to the difference frequency is radiated. As a laser beam source, it is possible to use a KTP-optical parametric oscillator (OPO) light source (that outputs light having two wavelengths) excited by an Nd—YAG laser, or two tunable laser diodes. It is possible to use the structure such as the structure described above in the first embodiment, but in the fourth embodiment, it is possible to set a waveguide length (x direction) to be longer in order to increase power of the terahertz wave. For instance, the waveguide length may be set to 40 mm. In this case, it is preferred to increase the size of the coupling member 4 together with the waveguide length in order that the generated terahertz wave 5 can be used more.

In this embodiment, if a frequency difference of the incident light is set to be 0.5 to 7 THz for example, the frequency of the radiated terahertz wave can be variable in the range. This embodiment can be applied to an application for inspection or imaging at a frequency in a specific terahertz band, for example, inspection of content of a specific substance in a pharmaceutical by adjusting the frequency to an absorption spectrum of the substance.

### Fifth embodiment

### Tomography Device

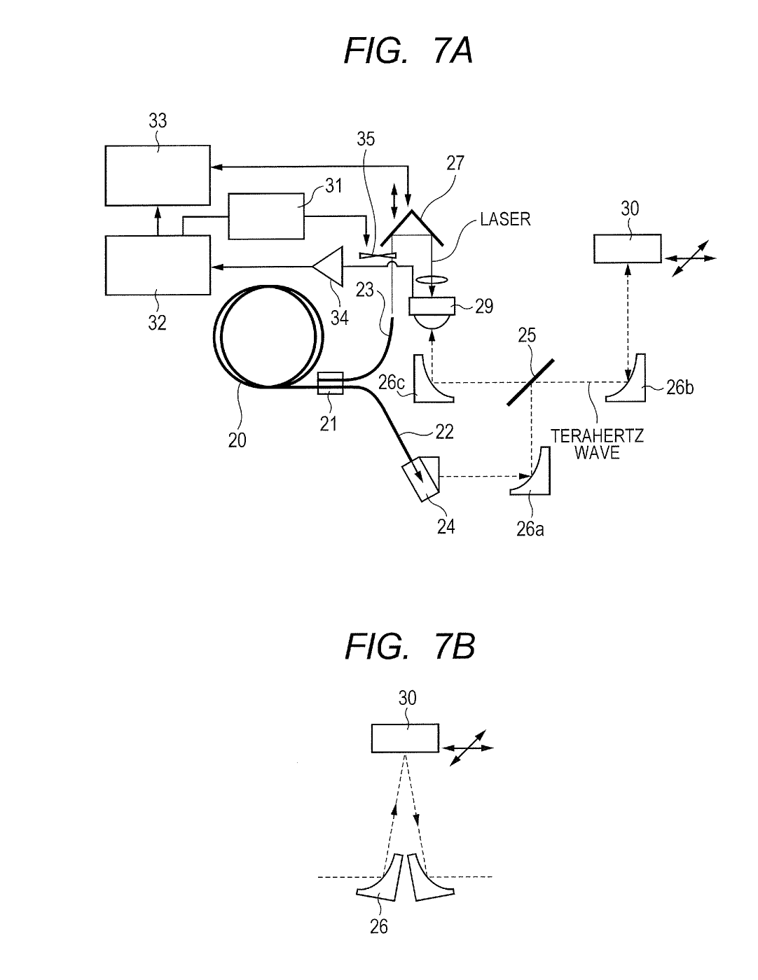

FIG. 7A illustrates an example of a tomography device by a terahertz time domain spectral system (THz-TDS) using the above-mentioned element as a terahertz wave generating unit. Here, a femtosecond laser 20 including an optical fiber is used as an exciting light source, and an output is obtained from a fiber 22 and a fiber 23 via a brancher 21. Typically, a center wavelength is 1.55 μm, a pulse width is 20 fs, and a repeating frequency is 50 MHz. However, the wavelength may be in a 1.06 μm band or the like, and the pulse width and the repeating frequency are not limited to the above-mentioned values. In addition, the fibers 22 and 23 of the output stage may include a highly nonlinear fiber for higher order soliton compression on the final stage or a dispersion fiber to perform prechirping for compensating for the dispersion due to optical elements or the like before reaching the terahertz wave generator and detectors. It is desired that these fibers be polarization-maintaining fibers.

The output from the fiber 22 on the terahertz wave generation side is connected to the optical waveguide 3 of the above-mentioned terahertz wave generator 24 according to the present invention (Cerenkov phase matching type element 24). In this case, it is desired to integrate a SELFOC (trademark) lens on a fiber end or to process the fiber end to be a pigtail type so that the output becomes equal to or smaller than a numerical aperture (NA) of the optical waveguide of the element 24 to increase coupling efficiency. As a matter of course, it is possible to use a lens (not shown) to achieve a space connection. In these cases, if antireflection coating is applied to the ends, it is possible to reduce Fresnel loss and undesired interference noise. Alternatively, by designing so that the NA and a mode field diameter are similar between the fiber 22 and the optical waveguide of the element 24, it is possible to bond the fiber 22 and the optical waveguide as direct coupling by butting (butt coupling). In this case, by appropriately selecting adhesive, it is possible to reduce adverse influence of reflection. If the pre-stage fiber 22 or the fiber laser 20 includes a non-polarization-maintaining fiber part, it is desired to stabilize polarization of the incident light to the Cerenkov radiation type element 24 by an inline type polarization controller. However, the exciting light source is not limited to the fiber laser. In this case, measures for stabilizing polarization can be reduced.

The generated terahertz wave is detected by a structure of a well-known THz-TDS method. In other words, the beam is collimated by a paraboloid mirror 26a and is split by a beam splitter 25. One of the branched beams irradiates a sample 30 via a paraboloid mirror 26b. The terahertz wave reflected by the sample 30 is condensed by a paraboloid mirror 26c and reaches a detector 29 formed of a photoconductive element to be received thereby.

The photoconductive element is typically an element obtained by forming a dipole antenna on a low-temperature grown GaAs. If the light source 20 is 1.55 μm, a second order harmonic is generated as a probe beam of the detector 29 by using an SHG crystal (not shown). In this case, it is desired to use periodically poled lithium niobate (PPLN) having a thickness of approximately 0.1 mm as the SHG crystal in order to maintain a pulse shape. If the light source 20 is a 1 μm band, it is possible to use a fundamental harmonic as the probe beam without generating the second order harmonic in the detector 29 of the photoconductive element made of a single layer of InGaAs or MQW.

In this device, for example, an optical chopper 35 is disposed on the probe beam side for modulation so that synchronous detection can be performed using a modulating portion 31 for driving the chopper and a signal acquiring portion 32 for acquiring a detected signal from the detector 29 via an amplifier 34. Then, a data processing and outputting portion 33 acquires a terahertz signal waveform while moving an optical delay device 27 as a delay unit using a PC or the like. The delay unit 27 may be any type as long as the delay unit can adjust a delay time between terahertz wave generation time in the element 24 as a generating unit (generation portion) and terahertz wave detection time in the detector 29 as a detecting unit (detection portion).

As described above, this device includes the generating unit including the terahertz wave generator of the present invention for generating a terahertz wave, the detecting unit for detecting the terahertz wave radiated from the generating unit, and the delay unit. Then, this device is constituted as a tomography device for imaging an internal structure of a sample, in which the detecting unit detects the terahertz wave that is radiated from the generating unit and is reflected by the sample, and the reflection light from the sample is analyzed.

In the system illustrated in FIG. 7A, the reflected wave from the sample 30 to be measured and the radiated terahertz wave have the same axis, and power of the terahertz wave is reduced to a half by the beam splitter 25. Therefore, it is possible to increase the number of mirrors 26 to have a noncoaxial structure so as to increase power of the terahertz wave, though the incident angle to the sample 30 is not 90 degrees (see FIG. 7B).

If there is a discontinuity position of the material in the sample 30, a reflection echo pulse appears at a time position corresponding to the discontinuity position in the acquired signal. If the sample 30 is scanned one-dimensionally, a tomogram is obtained. If the sample 30 is scanned two-dimensionally, a three-dimensional image can be obtained. In this embodiment, by using a terahertz wave beam having a large power using the above-mentioned generation portion 24, an S/N ratio can be improved in tomography measurement. In addition, because a relatively narrow terahertz wave pulse as a monopulse having a pulse width of 300 fs or smaller can be obtained, a depth resolution can be improved. Further, because the exciting laser using the fiber can be the radiating unit, downsizing and cost reduction of the device can be achieved. Here, although the LN crystal is used as the material, it is possible to use other electrooptic crystals such as LiTaOₓ, NbTaOₓ, KTP, DAST, ZnTe, GaSe, GaP, CdTe, and the like, which are described in Background Art. In this case, the LN crystal has a refractive index difference for the terahertz wave and the exciting light as described in Background Art, and hence the generated terahertz wave can be extracted in a noncollinear manner. However, other crystals do not necessarily have a large difference, and hence the generated terahertz wave may not be easily extracted. However, using a prism having a refractive index larger than that of the electrooptic crystal (for example, Si), the condition of Cerenkov radiation (v_{THz}<v_{g}) is satisfied so that the terahertz wave can be extracted externally.

### Sixth embodiment

### Detector

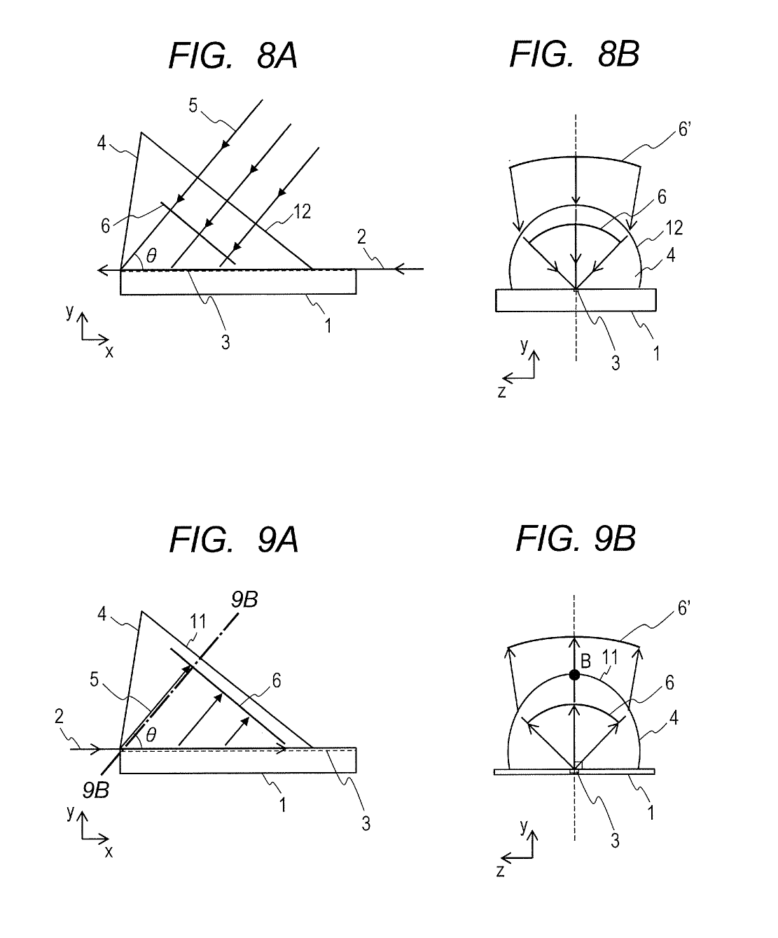

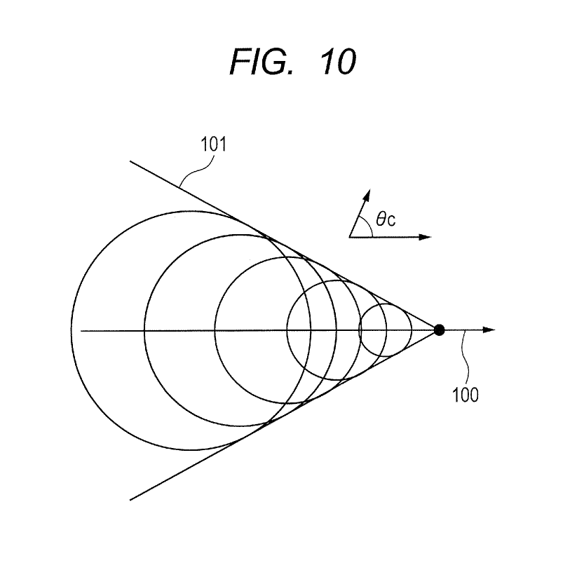

In a sixth embodiment of the present invention, an element similar to the element described above in the first to fourth embodiments serves as a detector of a terahertz wave. A terahertz wave detector of this embodiment is described with reference to FIGS. 8A and 8B. FIG. 8A is a cross-sectional view of the terahertz wave detector of this embodiment taken along a plane including the optical propagation direction of the optical waveguide 3 (x-axis) and the normal to the substrate (y-axis), and FIG. 8B is a cross-sectional view taken along a plane perpendicular to the optical propagation direction of the optical waveguide 3 (x-axis). Structures of the optical waveguide 3 and the coupling member 4 may be the same as in the first to fourth embodiments. Here, the laser beam 2 is caused to enter the optical waveguide 3 from the end surface opposite to that in the embodiments or examples described above. In this case, polarization of the laser beam 2 is linear polarization, and the laser beam 2 is caused to enter at a certain inclined angle (for example, 45 degrees) from the z-axis of the LN crystal constituting the optical waveguide 3 in the y-axis direction. In this case, the laser beam 2 radiated from the optical waveguide 3 has a phase difference between a z-axis component and a y-axis component of the electric field because of a double refraction property of the electrooptic crystal, and the laser beam 2 propagates as an elliptically polarized wave. Such a phase difference due to the natural double refraction is different depending on a type of the crystal, an incident polarization direction, and an optical waveguide length, and it is possible to adopt a structure in which the phase difference is zero.

As illustrated in FIG. 8A, when the terahertz wave 5 enters the terahertz wave incident plane 12 of the coupling member 4 (corresponding to the terahertz wave emitting plane 11 in the first embodiment and other embodiments), the following is possible. Specifically, in a reversed process of generating the terahertz wave, it is possible to perform interaction between the laser beam 2 propagating in the optical waveguide 3 and the terahertz wave 5 over the entire optical waveguide. The interaction is that a refractive index of the optical waveguide 3 in the z-axis changes so that a polarization state of the propagating light changes, because of a first-order electro-optic effect given by the electromagnetic field of the terahertz wave 5 to the electrooptic crystal (Pockels effect, namely a type of effect of the second-order nonlinear process). Specifically, the phase difference between the z-axis component and the y-axis component of the electric field of the laser beam 2 is changed by induced double refraction. Thus, an ellipticity of the elliptic polarization and a main axis direction of the laser beam 2 radiated from the optical waveguide 3 are changed. By detecting the change of the propagation state of the laser beam 2 by an external polarization element and a photodetector (not shown), it is possible to detect a magnitude of an electric field amplitude of the terahertz wave 5. For instance, it is possible to separate the two polarized light beams by a Wollaston prism and to perform detection while improving the S/N ratio by differential amplification using two photodetectors. The differential amplification is not essential, and it is possible to use a polarizing plate or the like so that only one photodetector detects the intensity. In order to compensate for the natural double refraction, it is possible to additionally dispose a phase compensating plate (such as a λ/4 plate) between an emitting end of the optical waveguide 3 and the polarization element.

In the cross section perpendicular to the optical propagation direction of the optical waveguide 3 (x-axis) illustrated in FIG. 8B, the terahertz wave 5 is refracted by the terahertz wave incident plane 12 of the coupling member 4 to be the wavefront 6 having a smaller radius of curvature than the wavefront 6′. Thus, the terahertz wave 5 is condensed to the optical waveguide 3 so that reception efficiency of the terahertz wave 5 can be improved. As a shape of the terahertz wave incident plane 12 of the coupling member 4, it is possible to adopt various shapes as described above in the first to fourth embodiments. It is possible to design a shape of the terahertz wave incident plane 12 in accordance with a shape of the terahertz wave 5 entering the detector. It is also considered to determine the shape of the terahertz wave incident plane 12 to be a shape that can be easily processed, for example, and to adjust the shape of the incident terahertz wave 5 by an external optical element so as to be received by the shape with high efficiency.

As described above, the terahertz wave detector of this embodiment has the following structure. Specifically, 0<r1<r2 is satisfied, where r1 represents the radius of curvature of the terahertz wave incident plane of the coupling member at the point A having a negative value when being convex in the propagation direction of the terahertz wave, and r2 represents the radius of curvature of the wavefront of the terahertz wave at the same point A. Then, in the plane perpendicular to the optical propagation direction of the optical waveguide, the cross-sectional shape of the coupling member is an elliptic or circular shape. In addition, the shape of the coupling member includes at least a part of a cone shape or an elliptic cone shape, the shape of the coupling member includes at least a part of an oblique cone shape or an oblique elliptic cone shape, or the shape of the coupling member includes at least a part of a paraboloid shape.

In this way, by using the element of the present invention as a detector, it is possible to improve reception efficiency of the terahertz wave 5 for detection. It is also possible to constitute the terahertz time domain spectroscopy device and the tomography device as described above in the embodiments by using this detector as a photodetecting unit. The generator in this case may be an element using a Cerenkov phase matching type as in the generator of the present invention or a generator using the conventional photoconductive element or the like.

In this embodiment, the laser beam 2 is caused to enter the optical waveguide 3 from the end opposite to that in the case of the generator, but the laser beam 2 may enter from the same end as in the case of the generator. In this case, because a matching length is decreased, signal intensity is decreased. In addition, the laser beam 2 may be a pulse or laser beams having two frequencies as described above in the fourth embodiment. When the laser beams having two frequencies are caused to enter, it is possible to detect a monochromatic terahertz wave corresponding to a difference frequency component therebetween. By changing the frequency difference between the two laser beams, an electric field amplitude of the terahertz wave having a desired frequency can be detected. As a method of detecting the terahertz wave, there is described a method of detecting a phenomenon in which an optical polarization state is changed by the first-order electro-optic effect of the combined terahertz wave. However, it is possible to adopt a method of detecting a phase change of light propagating in the optical waveguide as a change of an optical propagation state, or an optical signal of the difference frequency between a frequency of the light propagating in the optical waveguide and a frequency of the combined terahertz wave, namely detecting an optical beat signal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-149208, filed Jul. 3, 2012, and Japanese Patent Application No. 2013-111460, filed May 28, 2013, which are hereby incorporated by reference herein in their entirety.

### REFERENCE SIGNS LIST

1 . . . substrate, 2 . . . light, 3 . . . optical waveguide, 4 . . . coupling member, 5 . . . terahertz wave, 6, 6′ . . . wavefront of terahertz wave, 8 . . . core layer, 9, 10 . . . cladding layer, 11 . . . terahertz wave emitting plane of coupling member, 12 . . . terahertz wave incident plane

1. A terahertz wave generator, comprising:
an optical waveguide formed on a substrate so as to include a core layer of an electrooptic crystal; and
a coupling member configured to extract a terahertz wave into a space, which is generated from the optical waveguide when light propagates in the optical waveguide,
wherein 0<r1<r2 is satisfied, where r1 represents a radius of curvature of a terahertz wave emitting plane of the coupling member at a point A at which a line extending from the optical waveguide in a normal direction to a surface of the substrate crosses the terahertz wave emitting plane of the coupling member, in a plane perpendicular to an optical propagation direction of the optical waveguide, the radius of curvature r1 having a positive value when being convex in a propagation direction of the terahertz wave, and r2 represents a radius of curvature of a wavefront of the terahertz wave at the same point A, and
wherein a shape of the coupling member includes at least a part of one of a cone shape and an elliptic cone shape.

2. The terahertz wave generator according to claim 1, wherein in the plane perpendicular to the optical propagation direction of the optical waveguide, concerning a terahertz wave propagating in a range having an inclination smaller than 45 degrees from the propagation direction of the terahertz wave passing the point A, the radius of curvature of the terahertz wave emitting plane of the coupling member is smaller than the radius of curvature of the wavefront of the terahertz wave in the terahertz wave emitting plane of the coupling member.

3. The terahertz wave generator according to claim 1, wherein a cross-sectional shape of the coupling member in the plane perpendicular to the optical propagation direction of the optical waveguide is one of a circular shape and an elliptic shape.

4. The terahertz wave generator according to claim 3, wherein the cross-sectional shape of the coupling member in the plane perpendicular to the optical propagation direction of the optical waveguide is an ellipse, and the optical waveguide is positioned at a focal point of the ellipse.

5. (canceled)

6. The terahertz wave generator according to claim 5, wherein a distance between the point A of the terahertz wave emitting plane of the coupling member and the optical waveguide is larger than a distance between the point A of the terahertz wave emitting plane of the coupling member and an axis of one of the cone shape and the elliptic cone shape of the coupling member.

7. The terahertz wave generator according to claim 6, wherein:
the shape of the coupling member includes at least a part of a cone shape; and
0.16≦a/b≦0.22 is satisfied, where a represents a distance from the optical waveguide to a cone axis of the cone shape of the coupling member, and b represents a distance from the cone axis of the cone shape of the coupling member to the terahertz wave emitting plane of the coupling member, on a line extending from the optical waveguide in the normal direction to the surface of the substrate.

8. The terahertz wave generator according to claim 1, wherein the shape of the coupling member includes at least a part of one of an oblique cone shape and an oblique elliptic cone shape.

9. The terahertz wave generator according to claim 1, wherein the shape of the coupling member includes at least a part of a paraboloid shape.

10. The terahertz wave generator according to claim 1, wherein r_{A}1<r_{A}2 is satisfied, where r_{A}1 represents a radius of curvature of the terahertz wave emitting plane of the coupling member at the point A in a plane including the optical propagation direction of the optical waveguide and the normal direction to the surface of the substrate, and r_{A}2 represents a radius of curvature of the wavefront of the terahertz wave reaching the point A.

11. The terahertz wave generator according to claim 1, wherein a distance between the point A and the optical waveguide is gradually decreased along the optical propagation direction of the optical waveguide.

12. The terahertz wave generator according to claim 1, wherein a width of the optical waveguide in a direction perpendicular to both the optical propagation direction of the optical waveguide and the normal direction to the surface of the substrate is in a range of one to ten times as large as a main wavelength contained in the light.

13. The terahertz wave generator according to claim 1, wherein a height of the optical waveguide in the normal direction to the surface of the substrate is 1/10 or smaller of a main wavelength contained in the terahertz wave.

14. The terahertz wave generator according to claim 1, wherein the light propagates in the optical waveguide in a single mode.

15. The terahertz wave generator according to claim 1, wherein:
the optical waveguide comprises a core layer to be a core for the light and a cladding layer to be a clad for the light;
the cladding layer is sandwiched between the coupling member and the core layer; and
a thickness d of the cladding layer satisfies a<d<λ_{eq}/10, where a represents a thickness of the cladding layer when light intensity of the light becomes 1/e² where e is a base of natural logarithm of light intensity in the core layer, and λ_{eq} represents an equivalent wavelength in the cladding layer of a wavelength corresponding to a highest frequency of the terahertz wave.

16. The terahertz wave generator according to claim 1, wherein a thickness of the core layer of the optical waveguide is equal to or smaller than a half of an equivalent wavelength in the core layer of a wavelength corresponding to a highest frequency of the terahertz wave.

17. The terahertz wave generator according to claim 1, wherein a distance in which a part of the terahertz wave having a substantially large power propagates in the coupling member is equal to or larger than an equivalent wavelength in the coupling member of a wavelength corresponding to a highest frequency of the terahertz wave.

18-23. (canceled)

24. A terahertz wave detector, comprising:
an optical waveguide formed on a substrate so as to include a core layer of an electrooptic crystal; and
a coupling member configured to couple an incident terahertz wave to the optical waveguide, wherein:
a crystal axis of the electrooptic crystal of the optical waveguide is set to change a propagation state of light propagating in the optical waveguide when the terahertz wave enters the optical waveguide; and
0<r1<r2 is satisfied, where r1 represents a radius of curvature of a terahertz wave incident plane of the coupling member at a point A at which a line extending from the optical waveguide in a normal direction to a surface of the substrate crosses a terahertz wave emitting plane of the coupling member, in a plane perpendicular to the optical propagation direction of the optical waveguide, the radius of curvature r1 having a negative value when being convex in a propagation direction of the terahertz wave, and r2 represents a radius of curvature of a wavefront of the terahertz wave at the same point A; and
a shape of the coupling member includes at least a part of one of a cone shape and an elliptic cone shape.

25-26. (canceled)

27. A terahertz time domain spectroscopy device, comprising:
a generating unit configured to generate a terahertz wave;
a detecting unit configured to detect the terahertz wave radiated from the generating unit; and
a delay unit configured to adjust delay time between terahertz wave generation time in the generating unit and terahertz wave detection time in the detecting unit,
wherein the generating unit includes the terahertz wave generator according to claim 1.

28. A terahertz time domain spectroscopy device, comprising:
a generating unit configured to generate a terahertz wave;
a detecting unit configured to detect the terahertz wave radiated from the generating unit; and
a delay unit configured to adjust delay time between terahertz wave generation time in the generating unit and terahertz wave detection time in the detecting unit,
wherein the detecting unit includes the terahertz wave detector according to claim 24.

29. (canceled)
